(19) United States
(12) Patent Application Publication
(10) Pub. No.: US 2010/0253992 A1
(43) Pub. Date: Oct. 7, 2010

(54) LIGHT ADJUSTING DEVICE

(75) Inventor: Tatsuhiko OKITA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/750,993

(22) Filed: Mar. 31, 2010

(30) Foreign Application Priority Data
Apr. 1, 2009 (JP) 2009-088974

(51) Int. Cl. G02B 26/02

(52) U.S. Cl. 359/230

(57) ABSTRACT

A light adjusting device includes a base plate having an aperture; at least one light adjusting member configured to adjust the amount of light passing through the aperture; and at least one electromagnetic driving source configured to rotate the light adjusting member. The light adjusting member is provided with a rotating shaft member having magnetism. The light passing through the aperture is adjusted by rotating the rotating shaft member by using the electromagnetic driving source. The electromagnetic driving source includes a yoke and a winding coil wound on the yoke. The electromagnetic driving source is disposed on the base plate such that both front end sections of the yoke face toward the rotating shaft member in an area near and including a constraining point.

### CROSS-REFERENCE TO RELATED APPLICATIONS

The present application is based upon and claims the benefit of priority from the prior Japanese Patent Application No. 2009-088974 filed on Apr. 1, 2009; the entire contents of which are incorporated herein by reference.

### BACKGROUND OF THE INVENTION

1. Field of the Invention

The present invention relates to a light adjusting device.

2. Description of the Related Art

In recent years, with higher performance of small optical devices such as mobile equipment with imaging functions and a micro-videoscope, the shift in demand from conventional fixed-focus lens and fixed-aperture diaphragm to focusing lens and adjustable aperture has been growing in optical elements such as lenses and diaphragms. Naturally, smaller optical elements, better power savings, and more stable operation are anticipated.

Japanese Patent Application Laid-open No. 2002-303914 discloses a conventional electromagnetically driven shutter 900. In the conventional electromagnetically driven shutter 900, as shown in FIG. 15, a coil 950 is disposed on the circumference of a base plate 930 (shutter plate) in the thickness direction of the base plate 930. With this configuration, the volume of a yoke member 960 (coil core) can be made larger leading to achievement of a stable driving force. Moreover, miniaturization is possible because the configuration of the coil 950 is simple and the number of parts is small, and the assembly is simple. Incidentally, FIG. 15 is a perspective view of the configuration of the conventional electromagnetically driven shutter.

However, in the electromagnetically driven shutter 900 disclosed in the Japanese Patent Application Laid-open No. 2002-303914, because the coil 950 is installed on the base plate 930, the yoke member 960 separates from the base plate 930 by an amount equivalent to the thickness of the wound coil wire. For this reason, the front ends of the yoke member 960 face a magnet 940 (rotor), which is a rotating shaft, at a position distant from the base plate 930. The larger is the distance of the position of the front ends of the yoke member 960 facing the magnet 940 from the base plate 930, the greater is the flutter of movable members, and the more difficult is to achieve stable driving.

### SUMMARY OF THE INVENTION

The present invention has been made in view of the above discussion. It is an object of the present invention to suppress flutter of a movable member that moves with the rotation of a rotating shaft member and to stabilize operation while achieving higher yoke volume of a coil disposed on a base plate.

To solve the above problems and to achieve the above objects, a light adjusting device according to an aspect of the present invention includes a base plate having an aperture; at least one light adjusting member configured to adjust the amount of light passing through the aperture; and at least one electromagnetic driving source configured to rotate the light adjusting member. The light adjusting member is provided with a rotating shaft member having magnetism. The light passing through the aperture is adjusted by rotating the rotating shaft member by using the electromagnetic driving source to rotate the light adjusting member from a first static position retracted from the aperture to a second static position overlapping the aperture. The electromagnetic driving source includes a yoke and a winding coil wound on the yoke. The electromagnetic driving source is disposed on the base plate such that both front end sections of the yoke face toward the rotating shaft member in an area near and including a constraining point that defines the position of the rotating shaft member, regardless of the number of turns of the winding coil.

In the light adjusting device according to another aspect of the present invention, it is preferable that both the front end sections of the yoke are bent in a direction of an optical axis to face toward the rotating shaft member near the constraining point.

In the light adjusting device according to still another aspect of the present invention, it is preferable that both the front end sections of the yoke are bent in the vertical direction toward the base plate and substantially parallel to the rotating shaft member to face toward the rotating shaft member near the constraining point.

In the light adjusting device according to still another aspect of the present invention, it is preferable that the front end sections of the yoke are further bent toward the side of the rotating shaft member after bending them in a direction of an optical axis to face toward the rotating shaft member near the constraining point.

In the light adjusting device according to still another aspect of the present invention, it is preferable that at least the front end section of the yoke whereupon the winding coil has not been wound is thicker than a section whereupon the winding coil has been wound in a thickness direction of the base plate.

In the light adjusting device according to still another aspect of the present invention, it is preferable that each of the front end sections of the yoke is laminated by at least one plate member.

In the light adjusting device according to still another aspect of the present invention, it is preferable that the base plate has a notch such that the winding coil of the electromagnetic driving source can be set in the notch.

In the light adjusting device according to still another aspect of the present invention, it is preferable that a plurality of light adjusting members are provided and each of the light adjusting members has an aperture of different diameter.

In the light adjusting device according to still another aspect of the present invention, it is preferable that a plurality of light adjusting members are provided and each of the light adjusting members is provided with an optical lens having different optical characteristics.

In the light adjusting device according to still another aspect of the present invention, it is preferable that a plurality of light adjusting members are provided and each of the light adjusting members is provided with an optical filter having different optical characteristics.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of the configuration of a light adjusting device according to a first embodiment;

FIG. 2 is a perspective view of the configuration of the light adjusting device according to the first embodiment in the assembled condition;

FIG. 3 is a side view of the configuration of a light adjusting device according to a comparative example;

FIG. 4 is a side view of the configuration of the light adjusting device according to the first embodiment;

FIG. 5 is a perspective view of the state of an optical aperture of a light adjusting member in a first static position;

FIG. 6 is a perspective view of the state of the optical aperture of the light adjusting member in a second static position;

FIG. 7 is an exploded perspective view of the configuration of a light adjusting device according to a second embodiment;

FIG. 8 is a perspective view of the configuration of the light adjusting device according to the second embodiment in the assembled condition;

FIG. 9 is an exploded perspective view of the configuration of a light adjusting device according to a third embodiment;

FIG. 10 is a perspective view of the configuration of the light adjusting device according to the third embodiment in the assembled condition;

FIG. 11 is an exploded perspective view of the configuration of a light adjusting device according to a fourth embodiment;

FIG. 12 is a perspective view of the configuration of the light adjusting device according to the fourth embodiment in the assembled condition;

FIG. 13 is an exploded perspective view of the configuration of a light adjusting device according to a fifth embodiment;

FIG. 14 is a perspective view of the configuration of the light adjusting device according to the fifth embodiment in the assembled condition; and

FIG. 15 is a perspective view of the configuration of a conventional electromagnetically driven shutter.

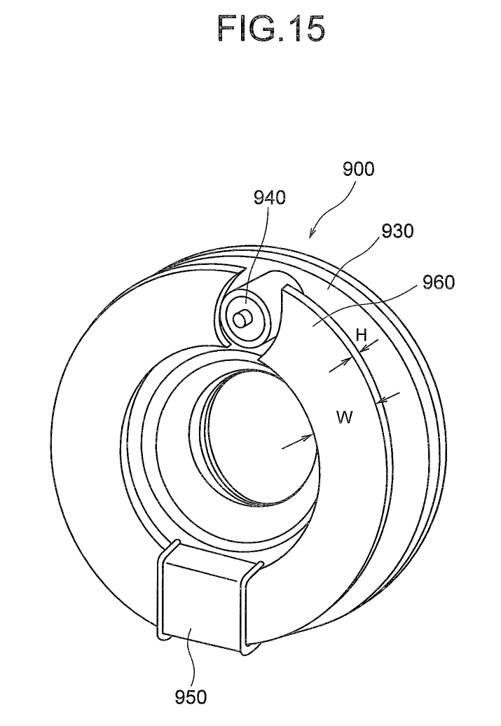

### DETAILED DESCRIPTION OF THE PREFERRED EMBODIMENTS

Exemplary embodiments of a light adjusting device according to the present invention are explained below with reference to accompanying diagrams. The present invention shall not be construed as being restricted by the embodiments explained below.

### First Embodiment

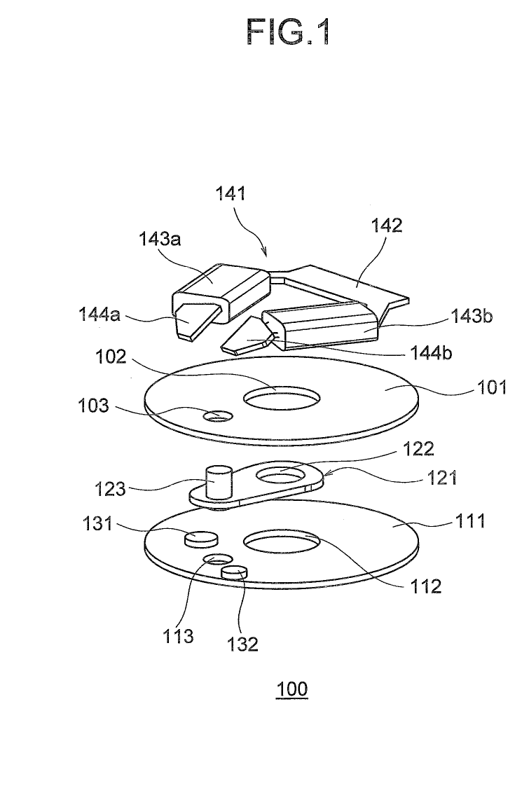

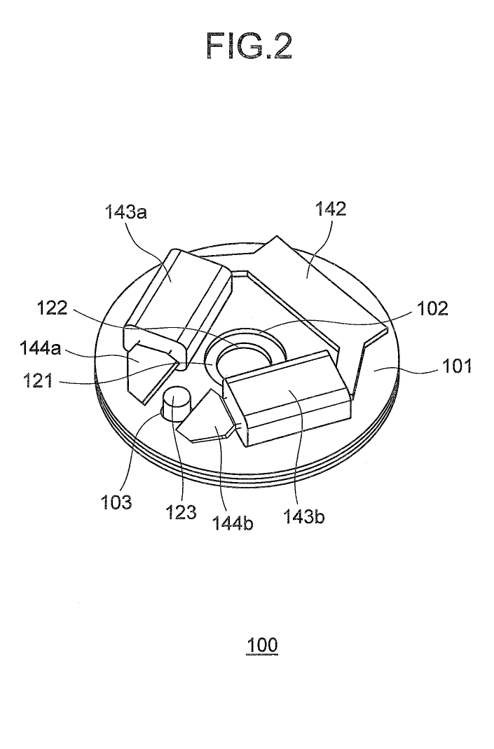

A light adjusting device 100 according to a first embodiment is explained below with reference to FIGS. 1 to 6. FIG. 1 is an exploded perspective view of the configuration of the light adjusting device 100 according to the first embodiment. FIG. 2 is a perspective view of the configuration of the light adjusting device 100 in an assembled condition.

The light adjusting device 100 includes a base plate 101 with an optical aperture 102 formed therein, a base plate 111 with an optical aperture 112 formed therein, a plate-shaped light adjusting member 121 with an optical aperture 122 formed therein, two restricting parts 131 and 132 that restrict the movement of the light adjusting member 121, and an electromagnetic driving source 141 for moving the light adjusting member 121. The base plate 101 and the base plate 111 are circular plates with the same outer diameter. The optical aperture 102 is provided at the center of the base plate 101 and the optical aperture 112 is provided at the center of the base plate 111. An aperture diameter of the optical aperture 122 is smaller than that of the optical aperture 102 and the optical aperture 112.

A rotating shaft hole 103 is formed in the base plate 101 and a rotating shaft hole 113 is formed in the base plate 111. The rotating shaft holes 103 and 113 are formed in such a manner that they mutually coincide at a position when the base plates 101 and 111 are stacked and the optical aperture 102 and the optical aperture 112 are aligned. The light adjusting member 121 is disposed between the base plates 101 and 111. A rotating shaft member 123 having magnetism is provided in the light adjusting member 121. The rotating shaft member 123 protrudes out from both sides of the light adjusting member 121. One end of the rotating shaft member 123 is rotatably inserted in the rotating shaft hole 103 while the other end is rotatably inserted in the rotating shaft hole 113.

Moreover, a spacer (not shown) is disposed between the base plate 101 and the base plate 111 to form a space in which the light adjusting member 121 can move rotationally.

The electromagnetic driving source 141 includes a plate-shaped yoke member 142 (yoke) and two winding coils (winding coil) 143a and 143b. The electromagnetic driving source 141 is disposed on the base plate 101. The winding coils 143a and 143b are wound at both end sections of the yoke member 142 such that both front end sections 144a and 144b of the yoke member 142 are exposed. Both the front end sections 144a and 144b of the yoke member 142 are bent toward the side of the base plate 101 such that each front end section faces the rotating shaft member 123.

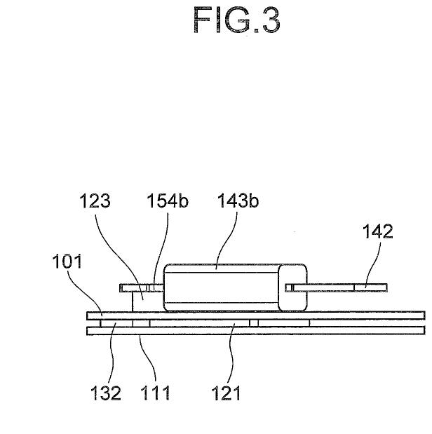

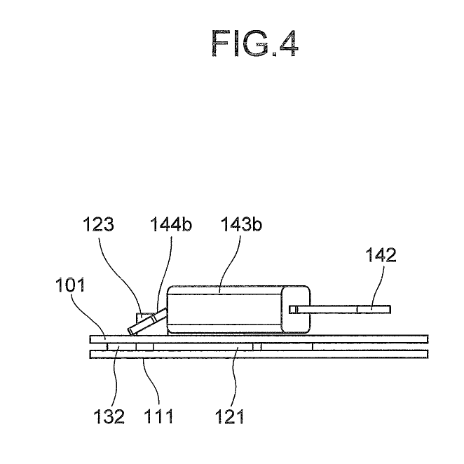

Next, both the front end sections 144a and 144b of the yoke member 142 are explained with reference to FIGS. 3 and 4. FIG. 3 is a side view of the configuration of a light adjusting device according to a comparative example. FIG. 4 is a side view of the configuration of the light adjusting device 100 according to the first embodiment. The members that have the same or similar configuration or the same or similar function in the comparative example shown in FIG. 3 and the light adjusting device 100 shown in FIG. 4 have been given like reference numerals.

In the comparative example shown in FIG. 3, the electromagnetic driving source 141 is disposed on the base plate 101 without bending a front end section 154b of the yoke member 142. In this configuration, the front end section 154b of the yoke member 142 faces the rotating shaft member 123 at a position that is distant from the light adjusting member 121 by an amount equivalent to the thickness of the winding coil 143b. Accordingly, the thicker is the winding coil 143b, the farther is the distance of the front end section 154b of the yoke member 142 from the light adjusting member 121, and the more likely is the possibility of occurrence of instability in driving the light adjusting member 121.

In contrast, in the light adjusting device 100 according to the first embodiment shown in FIG. 4, the front end section 144b of the yoke member 142 is bent toward the side of the light adjusting member 121, that is, toward the base plate 101. With this configuration, the front end section 144b of the yoke member 142 faces the rotating shaft member 123 closer to the light adjusting member 121. Such a configuration is similarly provided at the other front end section 144a.

Both the front end sections 144a and 144b of the yoke member 142 are bent so as to face toward the rotating shaft member 123 near the constraining point that defines the position of the rotating shaft member 123. From the view point that the position of the rotating shaft member 123 is defined by restricting the deflection of the rotating shaft member 123 in the diametric direction of the base plate 101, the constraining point is the circular area drawn by the rotating shaft hole 103 on the upper surface of the base plate 101.

“Near the constraining point” may be considered as the range, for instance, between the lower surface of a core of the winding coils 143a and 143b, and the lowermost surface of the winding coils 143a and 143b formed by winding coils on the core. With this configuration, by varying the bending direction of both the front end sections 144a and 144b depending on the thickness of the coil, both the front end sections 144a and 144b can each be made to face toward the rotating shaft member 123 near the constraining point regardless of the number of turns of the winding coils 143a and 143b.

Attention is drawn to the fact that “near the constraining point” may be considered as the area nearest to the constraining point in the rotating shaft member.

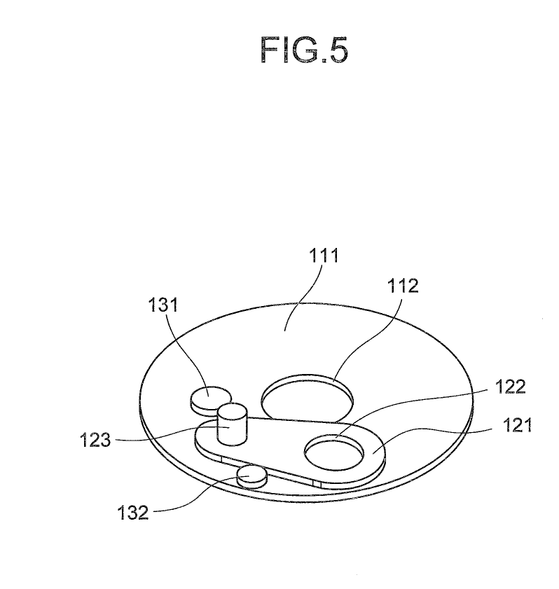

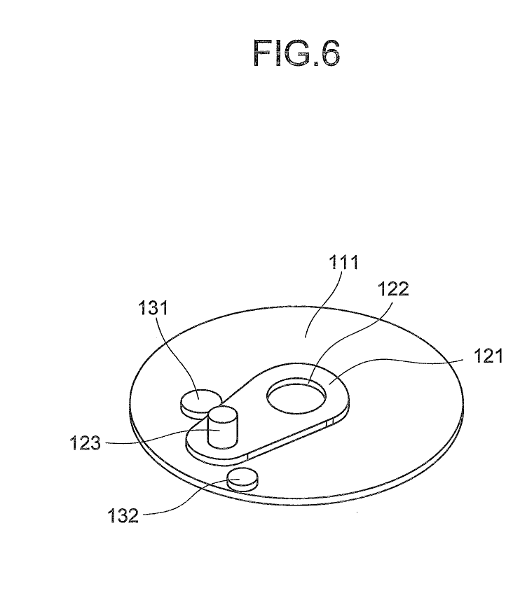

Next, the operation of the light adjusting device 100 is explained with reference to FIG. 5 and FIG. 6. FIG. 5 is a perspective view of a situation where the light adjusting member 121 is in a first static position state. FIG. 6 is a perspective view of a situation where the light adjusting member 121 in a second static position state. The base plate 101 and the electromagnetic driving source 141 are not shown in FIGS. 5 and 6.

When the electromagnetic driving source 141 rotationally drives the rotating shaft member 123, the light adjusting member 121 rotates with the central axis of the rotating shaft member 123 as the center of rotation. More specifically, the rotating shaft member 123 is rotated such that the light adjusting member 121 moves from the first static position to the second static position and vice-versa by the magnetic force generated in both the front end sections 144a and 144b of the yoke member 142 by supplying an electric current to the electromagnetic driving source 141.

As shown in FIG. 5, when the light adjusting member 121 is rotated so that it comes in contact with the restricting part 132, the optical aperture 122 of the light adjusting member 121 is at the first static position retracted from both the optical apertures 112 and 102. In this situation, the optical aperture of the light adjusting device 100 is equivalent to the optical aperture 102 of the base plate 101.

On the other hand, as shown in FIG. 6, when the light adjusting member 121 is rotated so that it comes into contact with the restricting part 131, the optical aperture 122 of the light adjusting member 121 is at the second static position, which coincides with both the optical apertures 112 and 102. In this situation, the optical aperture of the light adjusting device 100 is equivalent to the optical aperture 122 of the light adjusting member 121.

As explained above, in the light adjusting device 100 according to the first embodiment, as shown in FIG. 4, both the front end sections 144a and 144b of the yoke member 142 in the electromagnetic driving source 141 are bent toward the side of the light adjusting member 121.

Generally, when the electromagnetic driving source 141 is disposed directly on the base plate 101, the thickness of the winding coils 143a and 143b increases along with the increase in the number of turns of the coil. The yoke member 142 separates further from the upper surface of the plate-shaped light adjusting member 121 as the number of turns of the coil increases. This is also accompanied by further separation of both the front end sections 144a and 144b of the yoke member 142 from the light adjusting member 121. The result is that when the magnetic force generated in both the front end sections 144a and 144b of the yoke member 142 acts on the rotating shaft member 123 at a position distant from the light adjusting member 121, rotational deflection of the rotating shaft member 123 occurs, and the flutter of the light adjusting member 121 increases. As a result, stable operation of the light adjusting member 121 is difficult to achieve.

To address this issue, as shown in FIG. 4, both the front end sections 144a and 144b of the yoke member 142 of the light adjusting device 100 are bent toward the side of the light adjusting member 121 so as to face toward the rotating shaft member 123 near the constraining point. As a result, the flutter of the light adjusting member 121 is suppressed and stable operation is possible regardless of the number of turns in the winding coils 143a and 143b.

The light adjusting member 121 can be replaced by an optical lens whereby the light adjusting member 121 can be used as an optical lens desorption device. Moreover, the light adjusting member 121 can be provided in plurality and each of the light adjusting members 121 can be provided with an optical lens having different optical characteristics.

The light adjusting member 121 can be replaced by an optical filter whereby light adjusting member 121 can be used as an optical filter desorption device that is able to change the transmitted light intensity or the transmitted wavelength band. Moreover, the light adjusting member 121 can be provided in plurality and each of the light adjusting members 121 can be provided with an optical filter having different filter characteristics.

### Second Embodiment

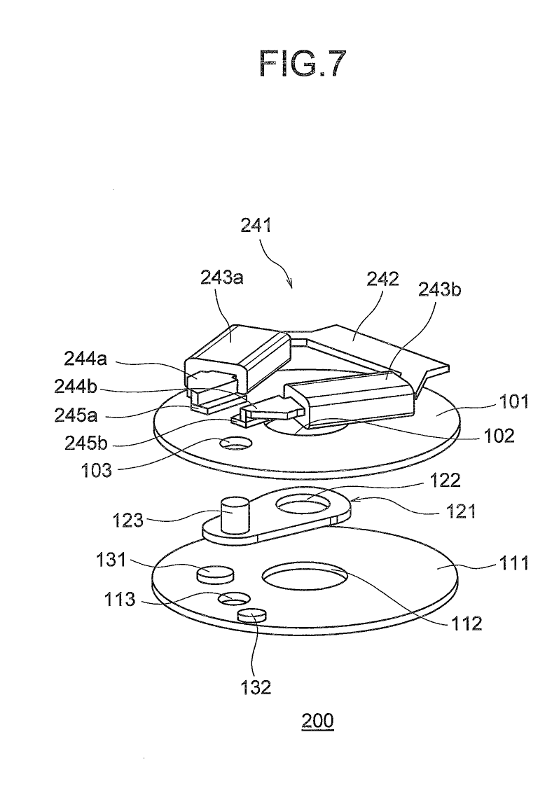

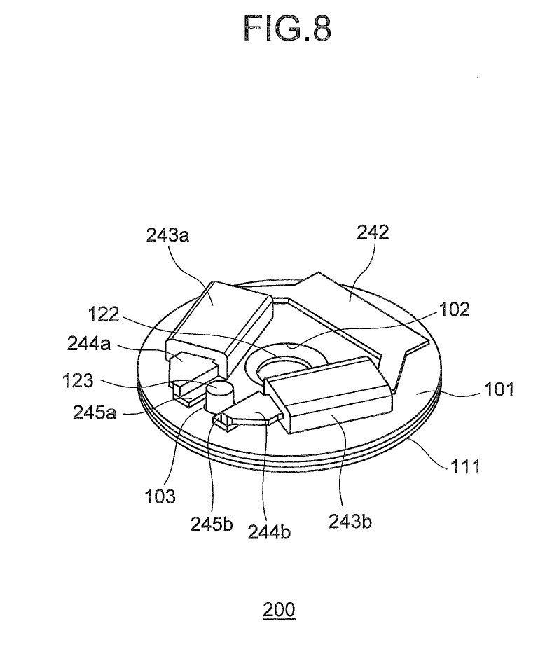

A light adjusting device 200 according to a second embodiment is explained below with reference to FIGS. 7 and 8. FIG. 7 is an exploded perspective view of the configuration of the light adjusting device 200. FIG. 8 is a perspective view of the configuration of the light adjusting device 200 in an assembled state. Structural elements in FIGS. 7 and 8 having the same or similar configuration or the same or similar function as the elements in the light adjusting device 100 according to the first embodiment are assigned the same reference numbers and their explanations are omitted.

An electromagnetic driving source 241 of the second embodiment includes a yoke member 242 (yoke) and winding coils 243a and 243b. The shapes of two front end sections 244a and 244b of the yoke member 242 in the electromagnetic driving source 241 of the second embodiment differ from the shapes of both the front end sections 144a and 144b of the first embodiment.

Specifically, both the front end sections 244a and 244b are bent toward the side of the light adjusting member 121 so as to make the front ends extending from the winding coils 243a and 243b substantially parallel to the rotating shaft member 123, and are subsequently bent perpendicular toward the side of the rotating shaft member 123. In other words, both the front end sections 244a and 244b of the yoke member 242 are first bent along the direction of the optical axis (vertical direction in FIGS. 7 and 8) of the light adjusting device 200, and subsequently bent so as to be substantially parallel with the light adjusting member 121 and the base plate 101.

The result is that front ends 245a and 245b of both the front end sections 244a and 244b each face toward the rotating shaft member 123 near the base plate 101, and near the light adjusting member 121, as shown in FIGS. 7 and 8. That is, both the front end sections 244a and 244b each face toward the rotating shaft member 123 near the constraining point that defines the position of the rotating shaft member 123.

In this way, both the front end sections 244a and 244b of the yoke member 242 are bent such that both the front end sections 244a and 244b of the yoke member 242 can each face toward the rotating shaft member 123 near the light adjusting member 121. With this configuration, the magnetic force generated in both the front end sections 244a and 244b acts near the light adjusting member 121, and therefore, the rotational deflection of the rotating shaft member 123 can be suppressed. As a result, the flutter during operation of the light adjusting member 121 is suppressed and stable operation is possible regardless of the number of turns in the winding coils 243a and 243b.

Other configurations, operations, and advantages are similar to those in the first embodiment.

### Third Embodiment

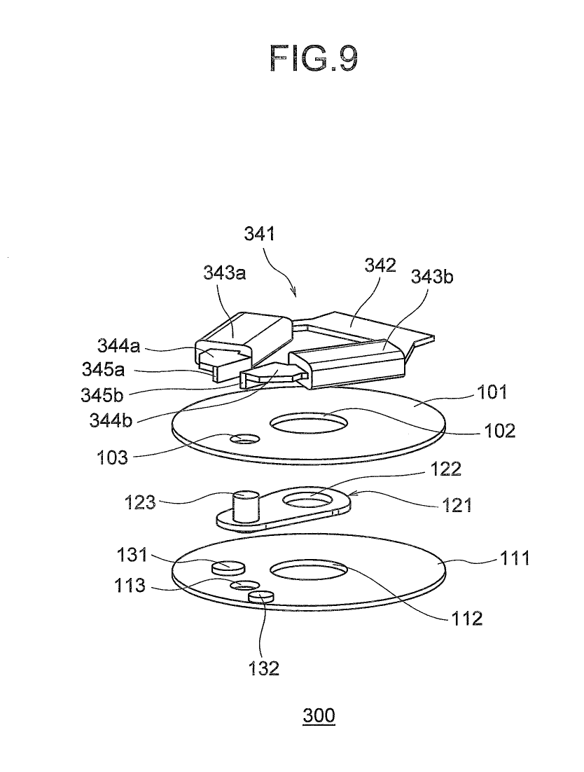

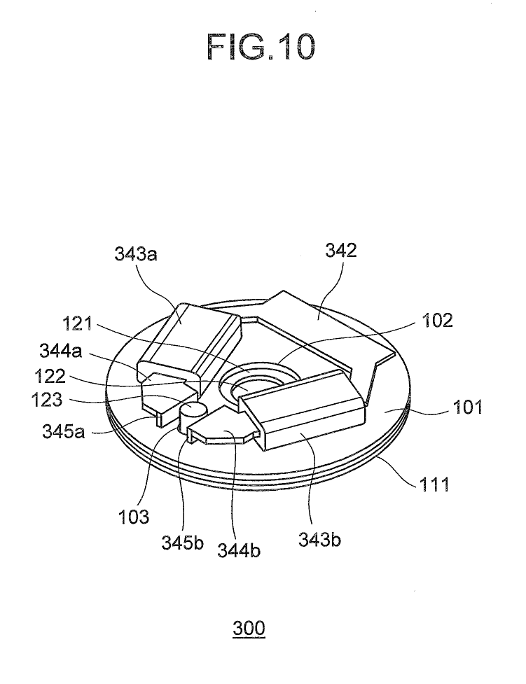

A light adjusting device 300 according to a third embodiment is explained below with reference to FIGS. 9 and 10. FIG. 9 is an exploded perspective view of the configuration of the light adjusting device 300. FIG. 10 is a perspective view of the configuration of the light adjusting device 300 in an assembled state. Structural elements in FIGS. 9 and 10 having the same or similar configuration or the same or similar function as the elements in the light adjusting device 100 according to the first embodiment are assigned the same reference numbers and their explanations are omitted.

An electromagnetic driving source 341 according to the third embodiment includes a yoke member 342 (yoke) and winding coils 343a and 343b. The shapes of two front end sections 344a and 344b of the yoke member 342 in the electromagnetic driving source 341 of the third embodiment differ from the shapes of both the front end sections 144a and 144b of the first embodiment.

Specifically, both the front end sections 344a and 344b are bent toward the side of the light adjusting member 121 so as to make the front ends extending from the winding coils 343a and 343b substantially parallel to the rotating shaft member 123. In other words, both the front end sections 344a and 344b of the yoke member 342 are bent along the direction of the optical axis (vertical direction in FIGS. 9 and 10) of the light adjusting device 300.

With this configuration, as shown in FIGS. 9 and 10, front ends 345a and 345b of both the front end sections 344a and 344b each face toward the rotating shaft member 123 near the base plate 101 and near the light adjusting member 121 so as to partially surround the rotating shaft member 123 protruding upward from base plate 101. Accordingly, both the front end sections 344a and 344b of the yoke member 342 each face toward the rotating shaft member 123 near the constraining point that defines the position of the rotating shaft member 123.

In this way, in the third embodiment, both the front end sections 344a and 344b of the yoke member 342 are bent toward the side of the light adjusting member 121, similar to the first and second embodiments, such that both the front end sections 344a and 344b of the yoke member 342 face toward the rotating shaft member 123 near the light adjusting member 121. With this configuration, the magnetic force generated in both the front end sections 344a and 344b acts near the light adjusting member 121, and therefore, the rotational deflection of the rotating shaft member 123 can be suppressed. As a result, the flutter during operation of the light adjusting member 121 is suppressed and stable operation is possible regardless of the number of turns in the winding coils 343a and 343b.

Furthermore, in the light adjusting device 300 of the third embodiment, because both the front end sections 344a and 344b of the yoke member 342 face toward the rotating shaft member 123 so as to partially surround it, the magnetic force generated in both the front end sections 344a and 344b of the yoke member 342 act uniformly on the rotating shaft member 123.

Other configurations, operations, and advantages are similar to those in the first embodiment.

### Fourth Embodiment

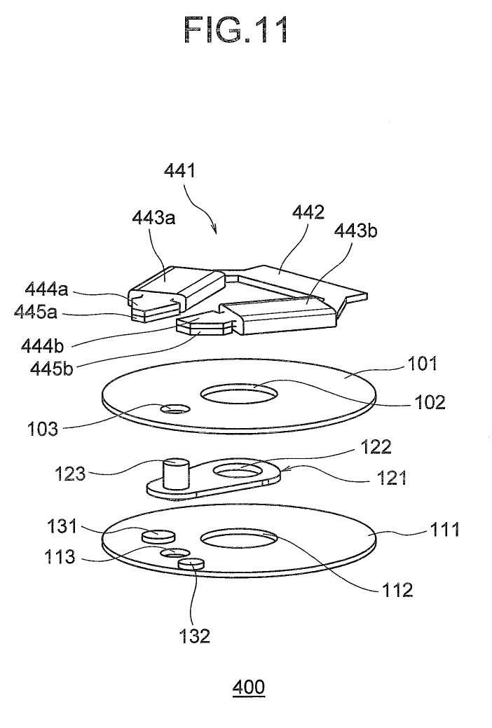

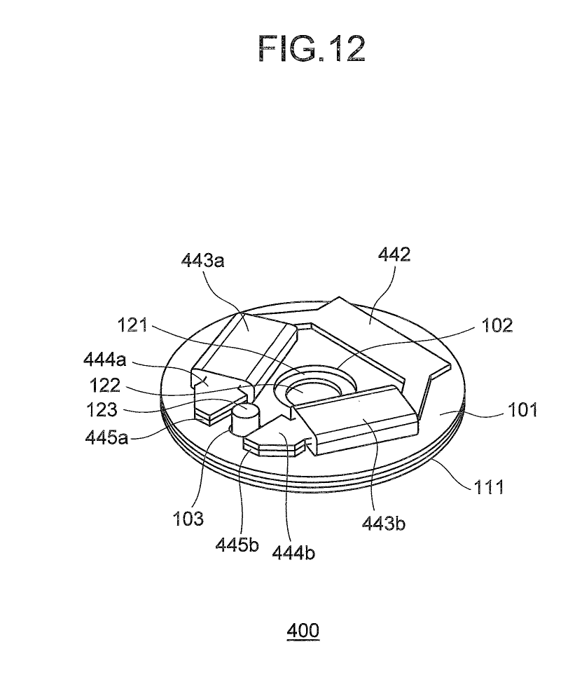

A light adjusting device 400 according to a fourth embodiment is explained below with reference to FIGS. 11 and 12. FIG. 11 is an exploded perspective view of the configuration of the light adjusting device 400. FIG. 12 is a perspective view of the configuration of the light adjusting device 400 in an assembled state. Structural elements in FIGS. 11 and 12 having the same or similar configuration or the same or similar function as the elements in the light adjusting device 100 according to the first embodiment are assigned the same reference numbers and their explanations are omitted.

An electromagnetic driving source 441 of the fourth embodiment includes a yoke member 442 (yoke) and winding coils 443a and 443b. Laminate members 445a and 445b are each laminated on the lower surface of front end sections 444a and 444b of the yoke member 442 in the electromagnetic driving source 441 of the fourth embodiment so that thickness in the optical axis direction (vertical direction in FIGS. 11 and 12) of the light adjusting device 400 is increased. As a result, the front end sections of yoke member 442 each face toward the rotating shaft member 123 near the base plate 101 and near the light adjusting member 121 so as to partially surround the rotating shaft member 123 protruding from the base plate 101.

The laminate members 445a and 445b should preferably be made of magnetic material.

In this way, by increasing the thickness of the front end sections of the yoke member 442 on the side of the light adjusting member 121, the front end sections of the yoke member 442 are made to face toward the rotating shaft member 123 near the light adjusting member 121. The result is that the front end sections of the yoke member 442 face toward the rotating shaft member 123 near the light adjusting member 121, and the magnetic force generated in the front end sections 444a and 444b, and the laminate members 445a and 445b, act near the light adjusting member 121; therefore, the rotational deflection of the rotating shaft member 123 can be suppressed. By virtue of this configuration, the flutter in the light adjusting member 121 can be suppressed and stable operation is possible regardless of the number of turns in the winding coils 443a and 443b.

Because the front end sections 444a and 444b, and the laminate members 445a and 445b of the yoke member 442 in the fourth embodiment face each other so as to partially surround the rotating shaft member 123, the magnetic force generated in the front end sections 444a and 444b, and the laminate members 445a and 445b of the yoke member 442, operates uniformly on the rotating shaft member 123.

Although the laminate members 445a and 445b are laminated on the front end sections 444a and 444b of the yoke member 442 in the light adjusting device 400 of the fourth embodiment, some other configuration can be employed. For example, instead of laminating the laminate members 445a and 445b on the front end sections 444a and 444b, the front end section of the yoke member 142 can be made thicker on the side of the light adjusting member 121.

Other configurations, operations, and advantages are similar to those in the first embodiment.

### Fifth Embodiment

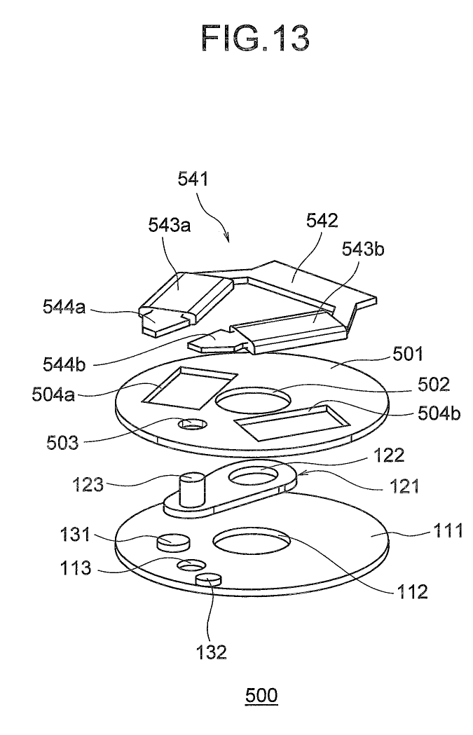

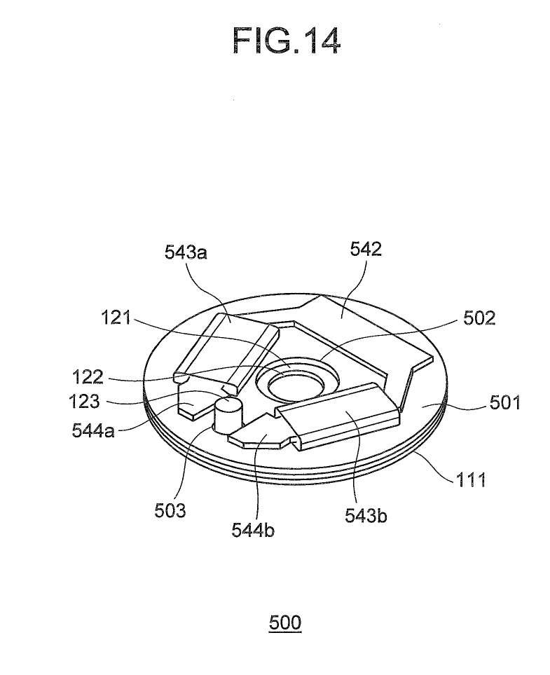

A light adjusting device 500 according to a fifth embodiment is explained below with reference to FIGS. 13 and 14. FIG. 13 is an exploded perspective view of the configuration of the light adjusting device 500. FIG. 14 is a perspective view of the configuration of the light adjusting device 500 in an assembled state. Structural elements in FIGS. 13 and 14 having the same or similar configuration or the same or similar function as the elements in the light adjusting device 100 according to the first embodiment are assigned the same reference numbers and their explanations are omitted.

An electromagnetic driving source 541 of the fifth embodiment includes a yoke member 542 (yoke) and winding coils 543a and 543b. The winding coils 543a and 543b are wound on both end sections of the yoke member 542, such that both front end sections 544a and 544b of the yoke member 542 are exposed.

An optical aperture 502 and a rotating shaft hole 503 are provided in a base plate 501 similar to the base plate 101 of the first embodiment. Moreover, as shown in FIGS. 13 and 14, notches (holes) 504a and 504b are provided in the base plate 501 at positions corresponding to the winding coils 543a and 543b respectively.

As shown in FIG. 14, when placing the electromagnetic driving source 541 on the base plate 501, the winding coils 543a and 543b are inserted into the notches (holes) 504a and 504b in the base plate 501. The result is that both the front end sections 544a and 544b of the yoke member 542 face toward the rotating shaft member 123 near the light adjusting member 121.

In this way, both the front end sections 544a and 544b of the yoke member 542 can be made to face toward the rotating shaft member 123 near the light adjusting member 121 without bending or increasing the thickness of the front end sections of the yoke member 542 in the light adjusting device 500 of the fifth embodiment. Accordingly, because the magnetic force generated in both the front end sections 544a and 544b act near the light adjusting member 121, the rotational deflection of the rotating shaft member 123 can be suppressed. As a result, the flutter during operation of the light adjusting member 121 can be reduced and stable operation is possible regardless of the number of turns in the winding coils 543a and 543b.

Other configurations, operations, and advantages are similar to those in the first embodiment.

As explained above, the light adjusting device according to the present invention is useful as a light adjusting device that attains stable driving of the light adjusting member while increasing the yoke volume of the coil.

The light adjusting device according to the present invention has an advantage that flutter in the light adjusting member can be suppressed and stable operation can be attained. This advantage is achieved by disposing the front end sections of the yoke to face toward the rotating shaft, which functions as a magnet, near the constraining point, while achieving higher yoke volume of a coil disposed on the base plate.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A light adjusting device comprising:
a base plate having an aperture;
at least one light adjusting member configured to adjust the amount of light passing through the aperture; and
at least one electromagnetic driving source configured to rotate the light adjusting member, wherein
the light adjusting member is provided with a rotating shaft member having magnetism,
the light passing through the aperture is adjusted by rotating the rotating shaft member by using the electromagnetic driving source to rotate the light adjusting member from a first static position retracted from the aperture to a second static position overlapping the aperture,
the electromagnetic driving source includes a yoke and a winding coil wound on the yoke, and
the electromagnetic driving source is disposed on the base plate such that both front end sections of the yoke face toward the rotating shaft member in an area near and including a constraining point that defines the position of the rotating shaft member, regardless of the number of turns of the winding coil.

2. The light adjusting device according to claim 1, wherein both the front end sections of the yoke are bent in a direction of an optical axis to face toward the rotating shaft member near the constraining point.

3. The light adjusting device according to claim 2, wherein both the front end sections of the yoke are bent in the vertical direction toward the base plate and substantially parallel to the rotating shaft member to face toward the rotating shaft member near the constraining point.

4. The light adjusting device according to claim 2, wherein both the front end sections of the yoke are further bent toward the side of the rotating shaft member after bending them in a direction of an optical axis to face toward the rotating shaft member near the constraining point.

5. The light adjusting device according to claim 2, wherein a plurality of light adjusting members are provided and each of the light adjusting members has an aperture of different diameter.

6. The light adjusting device according to claim 2, wherein a plurality of light adjusting members are provided and each of the light adjusting members is provided with an optical lens having different optical characteristics.

7. The light adjusting device according to claim 2, wherein a plurality of light adjusting members are provided and each of the light adjusting members is provided with an optical filter having different optical characteristics.

8. The light adjusting device according to claim 1, wherein at least the front end section of the yoke whereupon the winding coil has not been wound is thicker than a section whereupon the winding coil has been wound in a thickness direction of the base plate.

9. The light adjusting device according to claim 8, wherein each of the front end sections of the yoke is laminated by at least one plate member.

10. The light adjusting device according to claim 8, wherein a plurality of light adjusting members are provided and each of the light adjusting members has an aperture of different diameter.

11. The light adjusting device according to claim 8, wherein a plurality of light adjusting members are provided and each of the light adjusting members is provided with an optical lens having different optical characteristics.

12. The light adjusting device according to claim 8, wherein a plurality of light adjusting members are provided and each of the light adjusting members is provided with an optical filter having different optical characteristics.

13. The light adjusting device according to claim 1, wherein the base plate has a notch such that the winding coil of the electromagnetic driving source can be set in the notch.

14. The light adjusting device according to claim 13, wherein a plurality of light adjusting members are provided and each of the light adjusting members has an aperture of different diameter.

15. The light adjusting device according to claim 13, wherein a plurality of light adjusting members are provided and each of the light adjusting members is provided with an optical lens having different optical characteristics.

16. The light adjusting device according to claim 13, wherein a plurality of light adjusting members are provided and each of the light adjusting members is provided with an optical filter having different optical characteristics.
